(19) United States
(12) Patent Application Publication
(10) Pub. No.: US 2021/0026357 A1
(43) Pub. Date: Jan. 28, 2021

(54) MOVEMENT CONTROL SYSTEM AND MOVEMENT CONTROL METHOD

(71) Applicant: TOYOTA JIDOSHA KABUSHIKI KAISHA, Toyota-shi (JP)

(72) Inventors: Ryota OKUBI, Funabashi-shi (JP); Makoto HONDA, Tokyo (JP); Masato ENDO, Chofu-shi (JP); Tadaaki SAKAMOTO, Tokyo (JP); Takuya MURAKAMI, Tokyo (JP)

(73) Assignee: TOYOTA JIDOSHA KABUSHIKI KAISHA, Toyota-shi (JP)

(21) Appl. No.: 16/878,915

(22) Filed: May 20, 2020

(30) Foreign Application Priority Data
Jul. 26, 2019 (JP) 2019-137573

(51) Int. Cl. G05D 1/02; G06Q 50/30; G06Q 20/18; G06Q 20/08

(52) U.S. Cl. CPC G05D 1/0212; G06Q 50/30; G05D 2201/02; G06Q 20/085; G05D 1/0278; G06Q 20/18

(57) ABSTRACT

A movement control system includes a traveling controller configured to control, based on traveling route information, traveling of a moving object which a person is able to get on and off while the moving object is traveling, an output unit configured to output, to an occupant, information about a facility based on a traveling area of the moving object, a receiver configured to receive an inputting operation performed by the occupant for use or purchase of a service or a product provided in the facility, an acquisition unit configured to acquire destination information of the occupant getting on the moving object, and a deriving unit configured to derive traveling route information based on the acquired destination information.

### INCORPORATION BY REFERENCE

The disclosure of Japanese Patent Application No. 2019-137573 filed on Jul. 26, 2019 including the specification, drawings and abstract is incorporated herein by reference in its entirety.

### BACKGROUND

### 1. Technical Field

The disclosure relates to a technique of controlling a moving object that a person can get on and off while the moving object is traveling.

### 2. Description of Related Art

Japanese Unexamined Patent Application Publication No. 2016-45805 (JP 2016-45805 A) discloses a wander supporting system that supports a wandering behavior of a user who wanders around a city or a shopping mall by causing a small moving object that the user can get on and off to travel. The wander supporting system includes a closed loop path via a plurality of points set in advance and a plurality of small moving objects that autonomously travels on the closed loop path at a low speed.

### SUMMARY

In the case of the wander supporting system disclosed in JP 2016-45805 A, a user on board a small moving object is only on board the small moving object and cannot effectively use time on board the small moving object.

The disclosure provides a technique with which it is possible to effectively use time on board a moving object.

A first aspect of the disclosure relates to a movement control system including a traveling controller, an output unit, and a receiver. The traveling controller is configured to control, based on traveling route information, traveling of a moving object which a person is able to get on and off while the moving object is traveling. The output unit is configured to output, to an occupant, information about a facility in a traveling area of the moving object. The receiver is configured to receive an inputting operation performed by the occupant for use or purchase of a service or a product provided in the facility.

A second aspect of the disclosure relates to a movement control method. The method includes a step of controlling, based on traveling route information, traveling of a moving object which a person is able to get on and off while the moving object is traveling, a step of outputting, to an occupant, information about a facility in a traveling area of the moving object, and a step of receiving an inputting operation performed by the occupant for use or purchase of a service or a product provided in the facility.

According to the aspects of the disclosure, it is possible to provide a technique with which it is possible to effectively use time on board a moving object.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view of a moving object in an embodiment;

FIG. 2 is a diagram showing the outline of the configuration of a movement control system in the embodiment;

FIG. 3 is a diagram showing the functional configuration of the moving object of the movement control system;

FIG. 4 is a diagram showing the functional configuration of a server apparatus of the movement control system;

FIG. 5 is a diagram for describing the movement control system in a first embodiment;

FIG. 6 is a diagram for describing an ordering process in the movement control system;

FIG. 7 is a diagram for describing the movement control system in a second embodiment;

FIG. 8 is a flowchart of a check-in process in which the moving object is used;

FIG. 9 is a diagram for describing the movement control system in a third embodiment;

FIG. 10 is a flowchart of a process of proposing an action plan to an occupant; and

FIG. 11 is a diagram for describing the movement control system in a fourth embodiment.

### DETAILED DESCRIPTION OF EMBODIMENTS

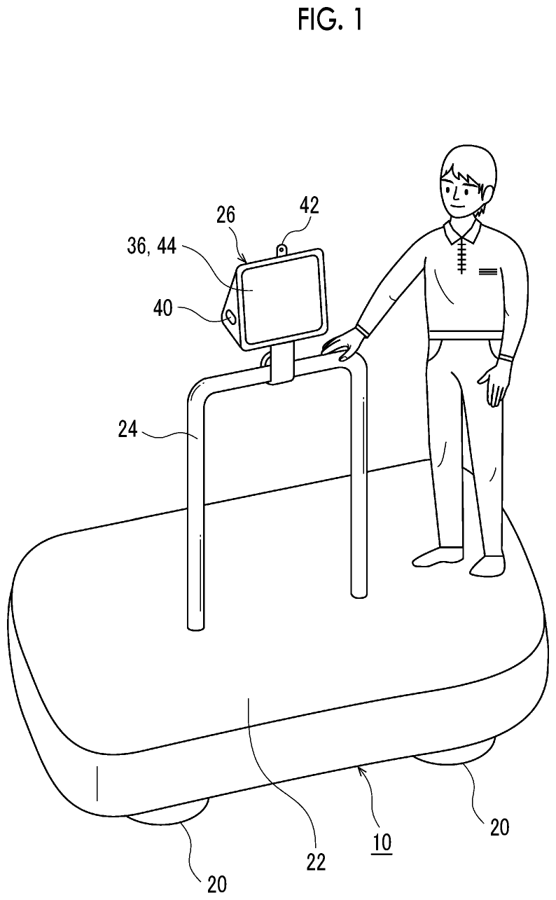

FIG. 1 is a perspective view of a moving object 10 in an embodiment. FIG. 1 shows a state where an occupant is on board the moving object 10. The moving object 10 travels on a walkway or a square and can autonomously travel at a speed of about 3 to 5 km per hour. The moving object 10 travels on a road surface on which a pedestrian is present at a speed similar to that of the pedestrian and a person can freely get on and off the moving object 10 while the moving object 10 is traveling. The moving object 10 moves around a plurality of facilities at the vicinity of a space in front of a station or an amusement park or reciprocates along a predetermined route between a station and an event venue or the like.

The moving object 10 is provided with wheels 20, a vehicle body 22, a handrail 24, and an information processing device 26. The information processing device 26 includes a receiver 36, a short-range wireless communication unit 40, an imaging unit 42, an output unit 44, and the like. The number of the wheels 20 is four and are rotated by a motor provided in the vehicle body 22. The vehicle body 22 includes a pedestal formed in a substantially flat shape such that a user can get on and off the vehicle body 22 while the moving object 10 is traveling and has such a size that four to six occupants in a standing position can get on the vehicle body 22. Inside the vehicle body 22, the motor, a battery, and a traveling control device are accommodated.

The handrail 24 includes a pair of columns standing on the vehicle body 22 and a horizontal bar connecting the columns to each other. An occupant holds the handrail 24 to stabilize a boarding posture. The information processing device 26 is fixed to the handrail 24. The receiver 36 and the output unit 44 are touch-enabled display panels. The receiver 36 receives an inputting operation performed by an occupant.

The imaging unit 42 is a camera that images the vicinity thereof. The short-range wireless communication unit 40 communicates with a portable terminal or an IC card. In addition, the information processing device 26 is provided with a processing unit and a communication unit that communicates with a server apparatus. The communication unit of the moving object 10 transmits reception information received by the receiver 36 to the server apparatus and receives information from the server apparatus.

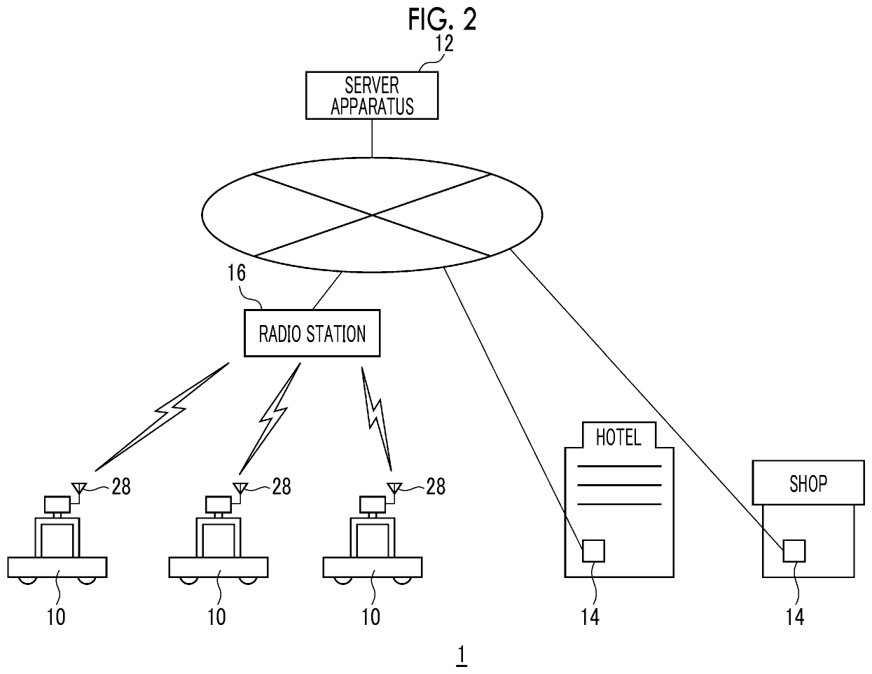

FIG. 2 shows the outline of the configuration of a movement control system 1 in the embodiment. The movement control system 1 is provided with the moving objects 10, a server apparatus 12, a facility terminal apparatus 14, and a radio station 16. The server apparatus 12 and the radio station 16 may be connected to each other via a network such as the Internet. The communication unit of each moving object 10 has a wireless communication function and is connected to the server apparatus 12 via the radio station 16, which is a base station.

Note that, the number of moving objects 10 is not limited to three. In the movement control system 1, a large number of moving objects 10 may generate reception information and periodically transmit the reception information to the server apparatus 12. The server apparatus 12 is installed in a data center and receives reception information transmitted from a communication unit 28 of the moving object 10.

The facility terminal apparatus 14 is provided in a facility that provides services and products and is connected to the server apparatus 12 via a network. The facility terminal apparatus 14 receives a request for use of a service or purchase of a product, from the moving object 10 via the server apparatus 12.

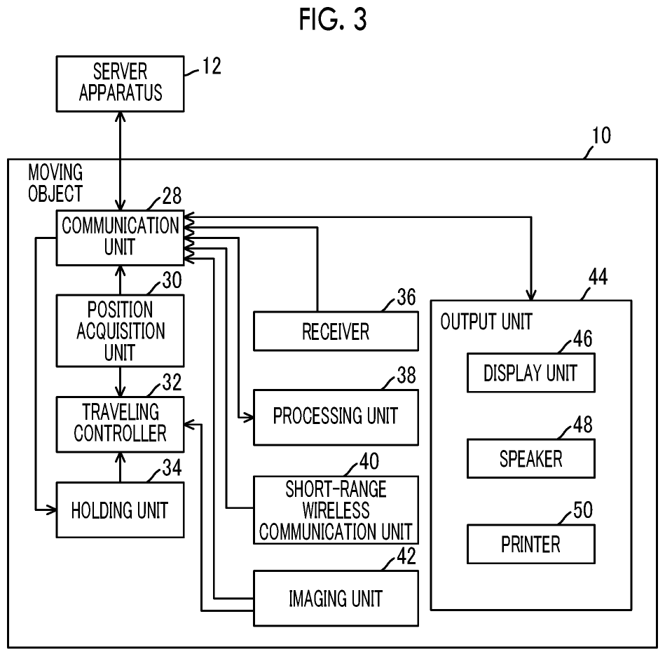

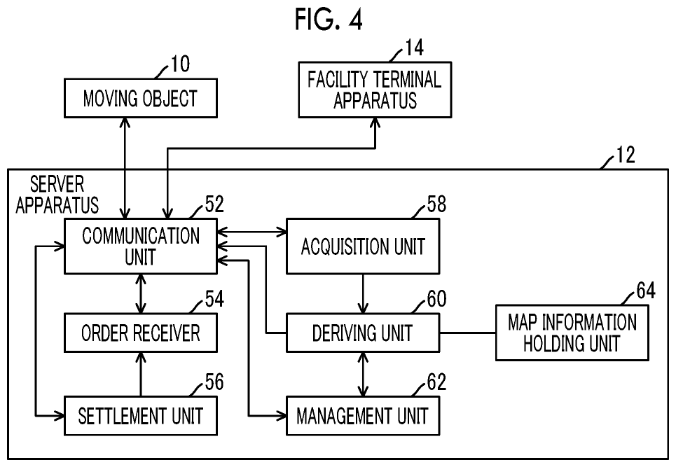

FIG. 3 shows the functional configuration of the moving object 10 of the movement control system 1. Each element described in FIG. 3 and FIG. 4 (which will be described later) as a functional block that performs various processes can be configured by using a circuit block, a memory, or another Large Scale Integrated circuit (LSI) in terms of hardware and is realized by a program or the like loaded into a memory in terms of software. Therefore, it can be understood by those skilled in the art that such functional blocks can be realized in various forms by means of hardware, software, or a combination thereof and with which such functional blocks can be realized is not limited to any of these.

The moving object 10 includes the communication unit 28, a position acquisition unit 30, a traveling controller 32, a holding unit 34, the receiver 36, a processing unit 38, the short-range wireless communication unit 40, the imaging unit 42, and the output unit 44. Each function of the moving object 10 is provided in the vehicle body 22 or the information processing device 26.

The communication unit 28 and the server apparatus 12 communicate information to each other. A vehicle ID is added to information transmitted from the communication unit 28, so that the server apparatus 12 can identify the moving object 10.

The position acquisition unit 30 acquires position information of a vehicle and a time at which the position information is acquired by using the global positioning system (GPS). The position information of the vehicle is used for traveling control in the traveling controller 32.

The holding unit 34 holds traveling route information which is used for traveling control in the traveling controller 32. The traveling route information indicates a target traveling route of the moving object 10. The traveling route information may be held in the holding unit 34 in advance or may be received from the server apparatus 12. In any case, the traveling route information is held in the holding unit 34. A plurality of kinds of traveling route information may be held and the traveling route information may be set to any of the plurality of kinds of traveling route information depending on the time of day and the position. The imaging unit 42 images the vicinity of the moving object 10 and an occupant of the moving object 10 to acquire a captured image.

The traveling controller 32 controls traveling of the moving object 10 based on the traveling route information. The traveling controller 32 controls the steering angle and the speed of the moving object 10 by using the position information and the captured image, such that the moving object 10 travels in accordance with the traveling route information. The traveling controller 32 may perform control such that the moving object 10 is temporarily stopped with respect to a pedestrian or the moving object 10 avoids or approaches a pedestrian based on traveling environment information acquired from the captured image as long as the moving object 10 does not deviate from a traveling route by a distance equal to or larger than a predetermined distance. In addition, the traveling controller 32 may perform control based on traveling information in which a traveling speed is set in addition to a traveling route.

The receiver 36 receives an inputting operation performed by the occupant which indicates use of a service or purchase of a product. The receiver 36 detects an inputting operation that is performed by the occupant by means of a touch-enabled display panel or a microphone. In addition, the receiver 36 receives an inputting operation indicating the destination of the occupant. The processing unit 38 performs an authentication process for specifying the occupant.

The short-range wireless communication unit 40 performs wireless communication over a distance of several centimeters and acquires settlement information from a portable terminal or a card of the occupant. In addition, the short-range wireless communication unit 40 may be configured to be able to perform wireless communication over a distance of several meters by using a communication standard such as Bluetooth (registered trademark) and to communicate with the portable terminal of the occupant. The short-range wireless communication unit 40 may be able to transmit and receive information to and from the portable terminal and in a case where the short-range wireless communication unit 40 transmits information to the portable terminal, the short-range wireless communication unit 40 functions as the output unit 44.

The output unit 44 outputs information to the occupant or a pedestrian in the vicinity of the moving object 10. The output unit 44 includes a display unit 46, a speaker 48, and a printer 50. The display unit 46 displays guidance information such as information about facilities, services, and products in a traveling area of the moving object 10. The display unit 46 may give information to the portable terminal of the occupant by displaying a QR code (registered trademark). The speaker 48 outputs the guidance information in the traveling area of the moving object 10 by means of a voice. The printer 50 outputs the guidance information in the traveling area or a receipt indicating the result of settlement by means of a paper sheet.

The output unit 44 may not be provided in the moving object 10 and may be provided in the server apparatus 12. For example, the server apparatus 12 may transmit the guidance information to the portable terminal of the occupant specified by the short-range wireless communication unit 40.

FIG. 4 shows the functional configuration of the server apparatus 12 of the movement control system 1. A communication unit 52 communicates with the moving object 10 and the facility terminal apparatus 14. An order receiver 54 receives, from the moving object 10, order information for use of a service or purchase of a product. When the order receiver 54 receives the order information, the order receiver 54 transmits the order information to the facility terminal apparatus 14 corresponding to the order information. When there is a reply indicating that the facility terminal apparatus 14 has received the order information, the order receiver 54 generates information indicating completion of an order and notifies the occupant of the information indicating the completion of the order via the output unit 44 of the moving object 10. A settlement unit 56 performs settlement for an ordered service or product. Note that, the settlement unit 56 may be provided in the facility terminal apparatus 14.

A management unit 62 manages a plurality of the moving objects 10. The management unit 62 holds position information of the moving objects 10 and traveling route information of the moving objects 10 in association with vehicle IDs. Accordingly, it is possible to figure out the moving object 10 traveling in a predetermined traveling area and perform transmission and reception of information.

An acquisition unit 58 acquires destination information and preference information of an occupant on board the moving object 10. The destination information and the preference information of the occupant may be input to the receiver 36 of the moving object 10 and may be acquired from a portable terminal of the occupant. The destination information may be information about a facility positioned in the vicinity of the moving object 10. The preference information indicates kinds of products or services such as a hamburger, coffee, bowling, or massage.

A deriving unit 60 derives traveling route information based on the destination information acquired by the acquisition unit 58. In addition, the deriving unit 60 may derive a recommended destination based on the preference information acquired by the acquisition unit 58 and derive traveling route information based on the derived destination. The deriving unit 60 derives a route along which the moving object 10 moves to a destination, based on position information of the moving object 10, the destination information of the occupant of the moving object 10, and map information held in a map information holding unit 64. The map information includes road information, facility position information, and information defining an area where the moving object 10 can travel. The traveling route information derived by the deriving unit 60 is transmitted to the moving object 10.

### First Embodiment

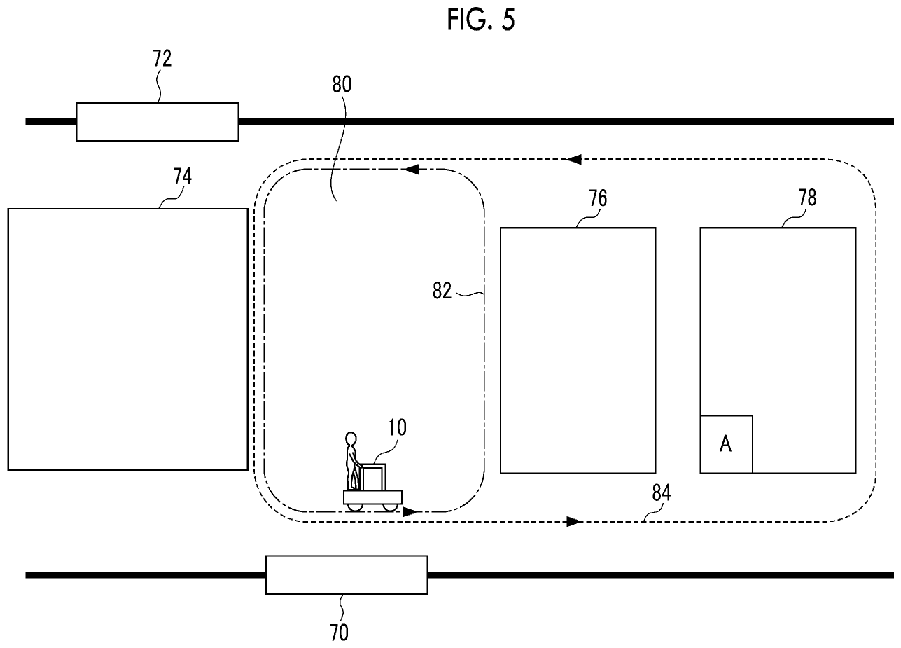

FIG. 5 is a diagram for describing the movement control system 1 in a first embodiment. FIG. 5 shows a map where a first complex 74, a second complex 76, a third complex 78, and a square 80 are provided in a place interposed between a first station 70 and a second station 72. Areas between the complexes or areas around the complexes and the square 80 are set as the traveling area of the moving object 10 where the moving object 10 can travel.

The first complex 74, the second complex 76, and the third complex 78 include facilities such as shops, restaurants, cultural facilities, sports facilities, movie theaters, and hospitals. The square 80 in front of a station is provided between the first complex 74 and the second complex 76 and the moving object 10 moves around the square 80 along a first traveling route 82. Note that, the moving object 10 moving around the square 80 may freely travel instead of traveling along the first traveling route 82 around an outer edge of the square 80 as long as the moving object 10 travels within the square 80 and the moving object 10 may approach a pedestrian, may avoid a pedestrian, and may be stopped.

A pedestrian can freely get on and off the moving object 10. The output unit 44 of the moving object 10 outputs, to an occupant, information about facilities based on the traveling area of the moving object 10, that is, information about facilities in the first complex 74, the second complex 76, and the third complex 78. In addition, the information about the facilities output by the output unit 44 may be output such that services or products provided in the facilities are shown. For example, the display unit 46 displays guidance about a store A or products sold at the store A.

The occupant of the moving object 10 touches the store A as the destination information, the receiver 36 receives the store A as the destination information, and the communication unit 28 transmits the destination information of the occupant to the communication unit 52 of the server apparatus 12. The destination information of the occupant may be acquired from a portable terminal of the occupant. The acquisition unit 58 of the server apparatus 12 acquires the destination information of the occupant, the deriving unit 60 derives a second traveling route 84 to the store A based on the acquired destination information, and the communication unit 52 transmits information about the derived second traveling route 84 to the communication unit 28 of the moving object 10. The traveling controller 32 of the moving object 10 controls traveling of the moving object 10 based on the information about the second traveling route 84. That is, the moving object 10 wanders along the first traveling route 82 set in advance until the destination information of the occupant is acquired and makes a switch to traveling to a destination along the second traveling route 84 when the destination information is received. In this manner, the moving object 10 can attract customers at the square 80 in front of a station and can guide an attracted occupant to a facility.

The output unit 44 outputs information about a facility indicated by the destination information to the occupant on the way to the destination. For example, in a case where coffee is sold at the store A, the display unit 46 displays the menu in the store A. When the occupant touches any of products in the menu for coffee, the display unit 46 displays a coffee purchase screen. Then, when the occupant touches a coffee purchase button, the receiver 36 receives an inputting operation that is performed by the occupant for purchase of a product provided in the store A. The display unit 46 displays a settlement screen for purchase of the product to prompt the occupant to perform settlement. When the occupant brings the portable terminal, an IC card, or the like close to the short-range wireless communication unit 40, the short-range wireless communication unit 40 receives settlement information of the occupant and the communication unit 28 transmits the settlement information to the server apparatus 12.

The settlement unit 56 receives the settlement information, performs settlement for the product, and generates settlement completion information. The communication unit 52 transmits the settlement completion information to the facility terminal apparatus 14 along with order information. When the receiver 36 receives an inputting operation for purchase of a product and the settlement unit 56 completes settlement, the order receiver 54 transmits order information indicating the purchase of the product to the facility terminal apparatus 14 of the store A.

When the facility terminal apparatus 14 receives the order information and receives an order, order completion information indicating that the order has been received is transmitted to the communication unit 28 of the moving object 10 via the server apparatus 12. The display unit 46 receives the order completion information and shows completion of the settlement and completion of the order to the occupant. In this manner, the occupant can purchase a product while the occupant is on board the moving object 10 and the occupant does not need to do other to receive the product after arriving at the store A while being on board the moving object 10. Accordingly, it is possible to effectively use time on board the moving object 10. In addition, the operator of the facility terminal apparatus 14 can prepare a product to be provided by seeing order information such that a waiting time of a customer is shortened.

Note that, in the embodiment, the occupant purchases a product while the occupant is on board. However, the disclosure is not limited thereto and the occupant may make a request for use of a service while the occupant is on board. In any case, with the movement control system 1, settlement for a selected product or service can be performed before arrival.

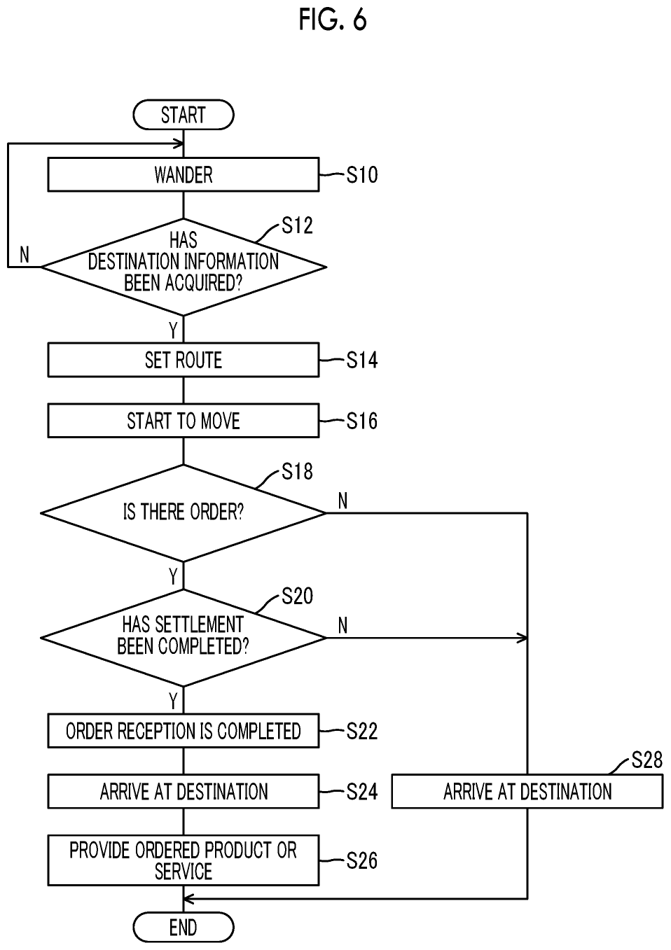

FIG. 6 is a diagram for describing an ordering process in the movement control system 1. The moving object 10 wanders along a traveling route set in advance (S10). Until destination information of an occupant is acquired (N in S12), the moving object 10 wanders. When the occupant inputs a destination to the receiver 36 of the moving object 10 and the acquisition unit 58 of the server apparatus 12 acquires the destination information from the moving object 10 (Y in S12), the deriving unit 60 derives a traveling route based on the destination information, the holding unit 34 of the moving object 10 receives and holds derived traveling route information (S14), and the traveling controller 32 starts control such that the moving object 10 moves to the destination based on the traveling route information held by the holding unit 34 (S16).

The output unit 44 outputs guidance information for a facility corresponding to the destination information. In a case where the occupant does not perform an inputting operation on the receiver 36 for purchase of a product or use of a service provided in the facility (N in S18), the present process is terminated when the moving object 10 arrives at the destination (S28) since there is no order.

In a case where the occupant performs an inputting operation on the receiver 36 for purchase of a product or use of a service provided in the facility and the receiver 36 receives the inputting operation for the purchase of the product or the use of the service (Y in S18), the display unit 46 displays a screen for settlement for the product or the service to prompt the occupant to perform the settlement by means of the short-range wireless communication unit 40 (S20).

In a case where the short-range wireless communication unit 40 receives no settlement information from a card or a portable terminal of the occupant, order reception is not completed (N in S20) and the present process is terminated after arrival at the destination. In a case where the short-range wireless communication unit 40 receives settlement information from the card or the portable terminal of the occupant, the settlement unit 56 of the server apparatus 12 performs settlement based on the settlement information (Y in S20) and order reception is completed (S22). Order information for which settlement has been completed is transmitted to the facility terminal apparatus 14 such that the operator of the facility terminal apparatus 14 starts preparation corresponding to the order information.

The traveling controller 32 of the moving object 10 causes the moving object 10 to travel toward the destination and when the moving object 10 arrives at the destination, the speaker 48 performs notification indicating that the moving object 10 has arrived at the destination by means of a voice (S24). The occupant gets off the moving object 10, moves to a store which is the destination, and receives provision of the ordered product or service (S26).

Note that, when the settlement is completed, the occupant may get off the moving object 10 before the moving object 10 arrives at the destination. For example, information about a preparation time taken to prepare the ordered product or service or a time at which the ordered product or service is scheduled to be provided is transmitted to the moving object 10 by the facility terminal apparatus 14 via the server apparatus 12 and the display unit 46 of the moving object 10 notifies the occupant of the preparation time taken to prepare the ordered product or service or the time at which the ordered product or service is scheduled to be provided by means of a displaying operation. Since the occupant does not need to do other than to arrive at the destination before the time at which the ordered product or service is scheduled to be provided, the occupant also can get off the moving object 10 and stop by another store when there is enough time left.

After guidance to the destination is finished, the traveling controller 32 of the moving object 10 may cause the moving object 10 to return to the first traveling route 82 from the second traveling route 84 and wander in the square 80 again.

### Second Embodiment

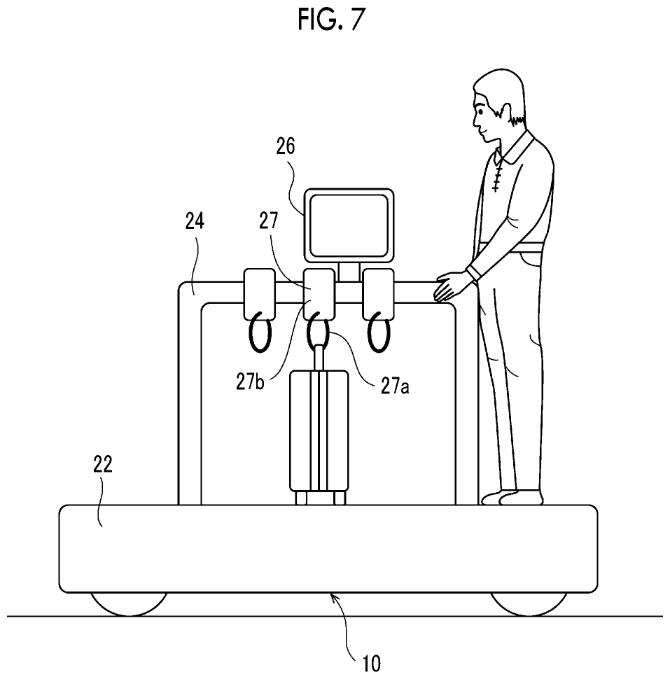

FIG. 7 is a diagram for describing the movement control system 1 in a second embodiment. In the case of the movement control system 1 in the second embodiment, an occupant can perform check-in for a facility such as hotel and receive key information for a room while the occupant is on board the moving object 10. In addition, after the check-in, the occupant can leave the moving object 10 after entrusting a package to the moving object 10. The package entrusted to the moving object 10 is delivered to the hotel by the moving object 10.

The processing unit 38 of the moving object 10 performs a check-in process in a case where destination information of the occupant received by the receiver 36 indicates a hotel. During the check-in process, the display unit 46 displays guidance for check-in and the receiver 36 receives an inputting operation performed by the occupant that indicates that the occupant wants to perform check-in for the hotel. In a case where the occupant performs check-in, the display unit 46 displays a screen for confirming whether or not the package of the occupant is to be entrusted and the receiver 36 receives an inputting operation performed by the occupant that indicates whether or not the package is to be entrusted.

When an authentication process for the occupant is completed, the processing unit 38 completes the check-in process. Identification information of the occupant which is used for the authentication process may be acquired from a card or a portable terminal of the occupant by means of the short-range wireless communication unit 40 and may be acquired with the receiver 36 receiving an inputting operation performed by the occupant. The processing unit 38 acquires authentication information for check-in from the facility terminal apparatus 14 via the server apparatus 12 and authentication of the occupant is completed when the identification information of the occupant coincides with the authentication information held in the facility terminal apparatus 14. Note that, the authentication process for the occupant may not be performed at the moving object 10 and may be performed at the server apparatus 12 or may be performed at the facility terminal apparatus 14. In any case, the authentication process is performed by means of collation between the identification information of the occupant acquired at the moving object 10 and the authentication information held in the facility terminal apparatus 14.

When the occupant performs check-in while the occupant is on board, a room in the hotel for which the check-in has been performed is assigned to the occupant and the occupant can receive key information for the room. A lock device provided for a door of each hotel room locks and unlocks the door based on the key information. The lock device acquires the key information from the portable terminal via short-range wireless communication or through an inputting operation and unlocks the door in a case where authentication of the key information is successful. The portable terminal of the occupant may be provided with an application program in which the key information can be used and may acquire the key information of the room from the short-range wireless communication unit 40 of the moving object 10. In addition, the portable terminal of the occupant may receive the key information by acquiring a QR code (registered trademark) displayed on the display unit 46 in the form of an image and may acquire the key information from the server apparatus 12. In addition, the printer 50 may give the key information to the occupant by printing the key information. In this manner, the occupant can receive key information of a facility for which check-in has been completed.

The moving object 10 includes a holding device 27 that holds a package. The holding device 27 includes a wire 27a for holding a package and a locking portion 27b fixed to the handrail 24. In a locked state, one end of the wire 27a is locked to the locking portion 27b and in an unlocked state, the one end is released from the locking portion 27b. It is possible to unlock the holding device 27 in a locked state by inputting password information. The password information may be set by the occupant and may be set by the processing unit 38.

The occupant can cause the holding device 27 to hold a package by inserting the wire 27a into a handle of the package in an unlocked state and locking the one end of the wire 27a with the locking portion 27b to achieve a locked state. In this manner, the occupant can entrust the package to the moving object 10.

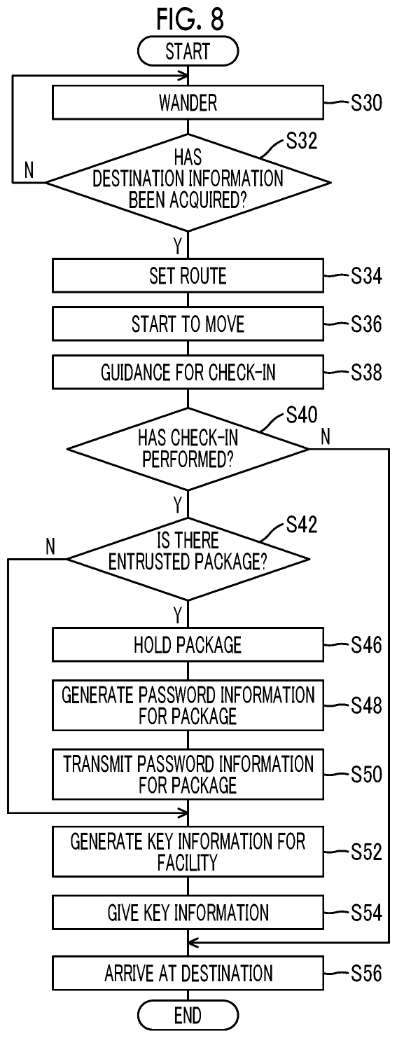

FIG. 8 is a flowchart of a check-in process in which the moving object 10 is used. The moving object 10 wanders along a traveling route set in advance (S30). Until destination information of an occupant is acquired (N in S32), the moving object 10 wanders. When the occupant inputs a destination to the receiver 36 of the moving object 10 and the acquisition unit 58 of the server apparatus 12 acquires the destination information from the moving object 10 (Y in S32), the deriving unit 60 derives a traveling route based on the destination information, the holding unit 34 of the moving object 10 receives and holds derived traveling route information (S34), and the traveling controller 32 starts control such that the moving object 10 moves to the destination based on the traveling route information held by the holding unit 34 (S36).

In a case where the destination information indicates a hotel, the display unit 46 performs a displaying operation for guidance about check-in (S38). For example, the display unit 46 displays “do you want check in to a hotel?” and options of “yes”, and “no”. In a case where the occupant touches “no” not to perform check-in (N in S40), the check-in process is terminated and the moving object 10 arrives at the destination (S56).

In a case where the occupant touches “yes” to perform check-in (Y in S40), the processing unit 38 of the moving object 10 performs an authentication process for the occupant to accept the check-in. After the authentication process for the occupant is completed, whether or not to entrust a package is checked (S42). For example, the display unit 46 displays “do you want entrust a package?” and options of “yes”, and “no”.

In a case where the occupant touches “yes” to entrust the package (Y in S42), the holding device 27 holds the package of the occupant (S44). The processing unit 38 generates password information for unlocking the holding device 27 (S48) and transmits the password information to the facility terminal apparatus 14 of the hotel via the server apparatus 12 (S50). In this manner, the occupant can entrust the package and a hotel employee can receive the password information and unlock the holding device 27 to unload the package from the moving object 10.

After the package is entrusted and in a case where the occupant touches “no” not to entrust the package (N in S42), the facility terminal apparatus 14 is instructed by the moving object 10 to issue key information, generates the key information for the hotel (S52), and transmits the key information to the server apparatus 12. The server apparatus 12 transmits the key information for the hotel to the moving object 10 and the short-range wireless communication unit 40 of the moving object 10 transmits the key information to a portable terminal of the occupant (S54). In this manner, it is possible to give key information for a room, for which check-in has been performed, to the occupant. The moving object 10 arrives at the hotel which is the destination (S56) and disembarks the occupant and the package at the hotel. Accordingly, the occupant can enter the room without checking in at the hotel and effectively use time on board.

Note that, the occupant may get off the moving object 10 after performing check-in at the moving object 10 and entrusting the package. In addition, the occupant may change the destination of the moving object 10 after check-in.

### Third Embodiment

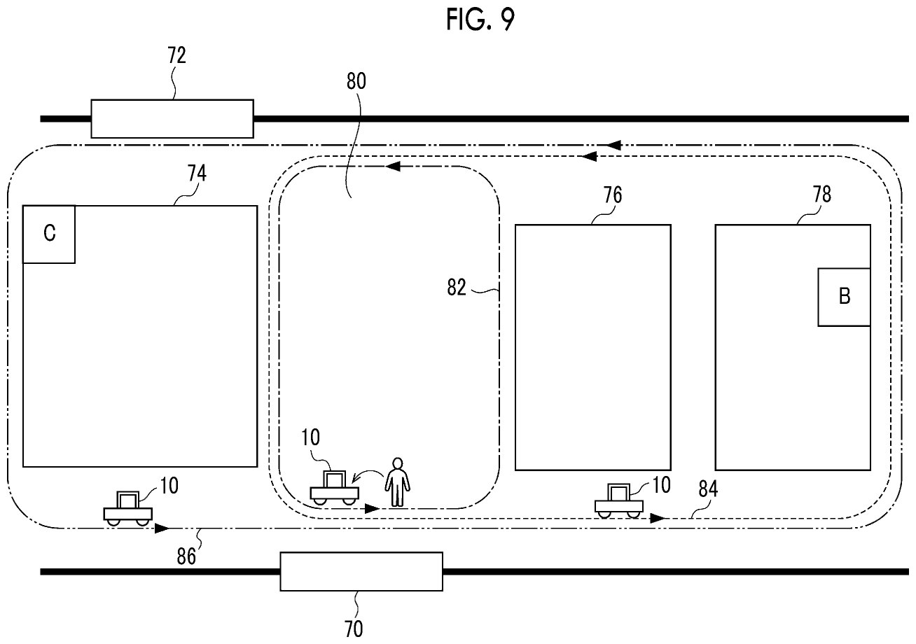

FIG. 9 is a diagram for describing the movement control system 1 in a third embodiment. In FIG. 9, the moving objects 10 travel along the first traveling route 82, the second traveling route 84, and a third traveling route 86 respectively and move around along routes set in advance. That is, the moving objects 10 travel along different traveling routes. The number of moving objects 10 traveling along the first traveling route 82 is not limited to one and a plurality of moving objects 10 may travel along the first traveling route 82. The same applies to the other traveling routes. Each moving object 10 may be provided with individual identification information that a user can visually recognize and may be provided with identification information that can be identified for each traveling route. For example, an individual identification number may be written on the vehicle body 22 of each moving object 10 and the color of the vehicle body 22 of the moving object 10 may be different for each traveling route.

The movement control system 1 in the third embodiment proposes an action plan to stop by a plurality of destinations to an occupant and guides the occupant such that the occupant can move to the destinations in the action plan while changing the moving objects 10. In FIG. 9, the movement control system 1 proposes an action plan in which a store B and a store C are destinations and performs guidance to show which moving object 10 the occupant needs to get on such that the occupant can efficiently move to the store B and the store C. In a case where the moving objects 10 travel along different traveling routes, it may be difficult for a user to know which moving object 10 travel to which place. Since guidance about information for changing the moving objects 10 is provided along with an action plan proposal, an action plan for entertaining the user can be proposed and the user can easily move to a plurality of destinations as planned while being on board the moving object 10. In addition, the occupant can receive an action plan while being on board the moving object 10 and thus the occupant is further motivated to get on the moving object 10.

In order to derive an action plan for the occupant, the acquisition unit 58 of the server apparatus 12 acquires at least one of destination information and preference information of the occupant via the moving object 10. The display unit 46 displays a screen on which a destination can be input or a screen on which the preference information can be input and the receiver 36 receives the destination information or the preference information of the occupant. In addition, the receiver 36 may receive the destination information or the preference information from a portable terminal of the occupant via the short-range wireless communication unit 40. The destination information may be the name of a store in a traveling area and may be a point registered in schedule information held in the portable terminal of the occupant. The preference information may be a kind of food such as “cafe”, “pasta”, and “ramen” and a kind of hobby such as “movie” and “music”. In addition, the receiver 36 may receive an able-to-act time for which the occupant spends time between the first station 70 and the second station 72.

The deriving unit 60 derives a plurality of destinations based on at least one of the destination information and the preference information of the occupant and derives action plan information for determining the order in which the destinations are visited. In addition, the deriving unit 60 may derive a moving route for visiting the destinations and may derive action plan information conforming to the able-to-act time of the occupant.

The action plan information derived by the deriving unit 60 includes information about the destinations, information about a moving route to move to the destinations, transfer information of the moving objects 10 to get on, information about an expected time of arrival for each of the destinations. In FIG. 9, the deriving unit 60 derives the store B and the store C based on the destination information of the occupant and derives a moving route to move from a current location to the store B and the store C in this order. The deriving unit 60 may derive a moving route to the destinations based on position information of the destinations and traveling routes of the moving objects 10. Note that, although the action plan information is derived by the deriving unit 60 of the server apparatus 12 in the embodiment, the action plan information may be derived by the moving object 10. The derived action plan information may be transmitted to the facility terminal apparatus 14. Therefore, the operator of the store B or the store C can perform preparation.

The transfer information of the moving objects 10 is derived based on a plurality of traveling routes of the moving objects 10 and includes identification information of the moving objects 10 to get on in accordance with the destinations. For example, when the occupant gets on the moving object 10 traveling along the second traveling route 84 at the store B shown in FIG. 9, the occupant cannot arrive at the store C. However, the occupant can arrive at the store C when the occupant gets on the moving object 10 traveling along the third traveling route 86. Therefore, transfer information indicating that the occupant needs to get on the moving object 10 traveling along the second traveling route 84 or the third traveling route 86 to arrive at the store B and the occupant needs to get on the moving object 10 traveling along the third traveling route 86 to arrive at the store C is generated.

The information about the expected time of arrival for each of the destinations is derived based on a moving distance and a facility use time set for each facility in advance.

The output unit 44 provides the derived action plan information to the occupant. The display unit 46 may display the action plan information and the printer 50 may provide the action plan information by printing the action plan information. In addition, the output unit 44 may provide the action plan information to the portable terminal of the occupant by means of the short-range wireless communication unit 40. In any case, the output unit 44 outputs the action plan information to the occupant. Accordingly, the occupant can efficiently move to the destinations based on the action plan information.

Note that, the acquisition unit 58 may acquire position information from a portable terminal of a user and the deriving unit 60 may monitor the progress of an action plan based on the position information of the user and information about an expected time of arrival at each destination indicated by action plan information and may derive the action plan information again in a case where the progress is delayed to a degree equal to or greater than a predetermined value. For example, in a case where the user spends a lot of time at the store B, the deriving unit 60 may determine that there is no time to visit the store C and change a destination to a store that is closer to the store B than the store C. The deriving unit 60 determines whether or not the store C can be used based on an able-to-act time, a moving distance, and a facility use time set for each facility in advance. In this manner, the deriving unit 60 can propose the action plan information again.

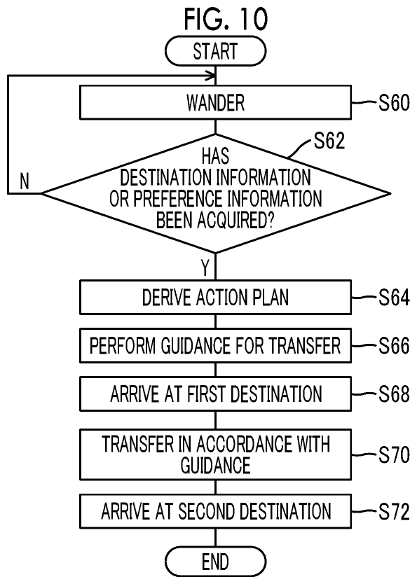

FIG. 10 is a flowchart of a process of proposing an action plan to an occupant. The moving object 10 wanders along a traveling route set in advance (S60). Until destination information of an occupant is acquired (N in S62), the moving object 10 wanders. When the occupant inputs a destination to the receiver 36 of the moving object 10 and the acquisition unit 58 of the server apparatus 12 acquires both or one of the destination information and preference information from the moving object 10 (Y in S62), the deriving unit 60 derives action plan information based on both or one of the destination information and the preference information (S64).

The output unit 44 outputs the action plan information to the occupant. For example, the output unit 44 of the moving object 10 moving around along the first traveling route 82 outputs, to the occupant, information about an action plan to move from a current location to the store B and from the store B to the store C. The action plan information includes transfer information indicating that a transfer to the moving object 10 moving around along the second traveling route 84 or the third traveling route 86 is to be made to go to the store B and the occupant sees the transfer information and transfers from the moving object 10 traveling along the first traveling route 82 (S66).

The occupant gets on the moving object 10 moving around along any of the second traveling route 84 and the third traveling route 86 and arrives at the store B which is a first destination (S68). After the occupant visits the store B, the occupant gets on the moving object 10 moving around along the third traveling route 86 based on the action plan information to change the moving objects 10 at the store B (S70) and arrives at the store C which is a second destination (S72). In this manner, it is possible to provide an action plan to enjoy facilities in the traveling area of the moving objects 10, to a user. In addition, in a case where the moving objects 10 move around along different traveling routes, it is possible to perform guidance to show which moving object 10 a user needs to get on.

### Fourth Embodiment

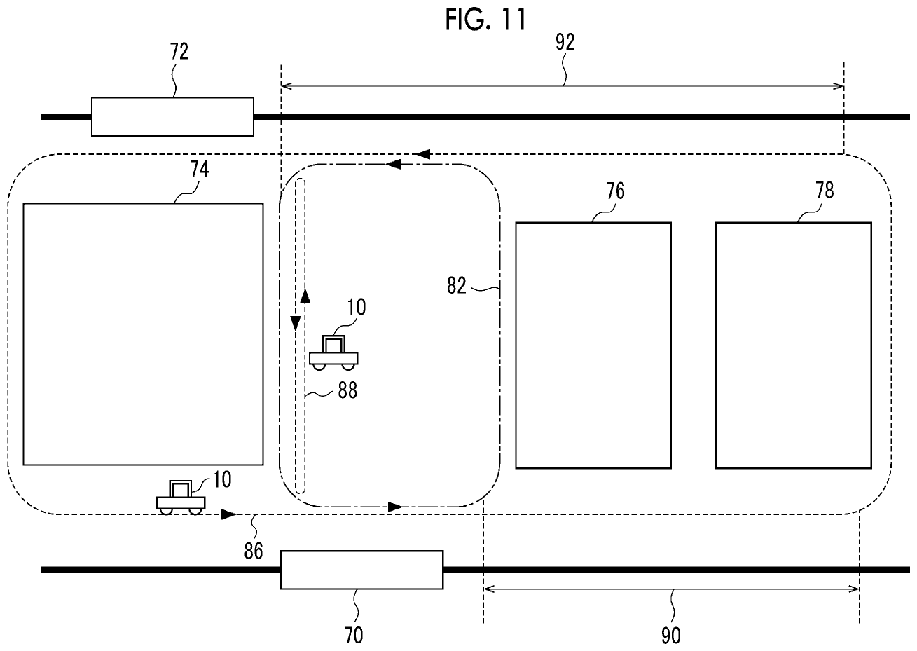

FIG. 11 is a diagram for describing the movement control system 1 in a fourth embodiment. In the case of the movement control system 1 in the fourth embodiment, at least one of the traveling speed and the traveling route of the moving object 10 is set depending on the time of day. The moving object 10 travels based on traveling information in which a traveling speed and a traveling route are set. Since the traveling speed and the traveling route of the moving object 10 can be changed depending on the time of day, the moving object 10 can travel in accordance with what a user needs.

In FIG. 11, as the traveling route of the moving object 10, the first traveling route 82, a second traveling route 88, and the third traveling route 86 are shown. The traveling route is set depending on the time of day. The first traveling route 82 is a route for moving around in the square 80 and the traveling route is set thereto at all the times of day when the moving object 10 is to be operated, for example, at a period of time from 7:00 am to 7:00 pm. The second traveling route 88 is a route for linearly reciprocating between the first station 70 and the second station 72 and is set at a period of time from 7:00 am to 9:00 am and from 5:00 pm to 7:00 pm (at commute hours). The third traveling route 86 is a route for moving around outer sides of the first complex 74, the second complex 76, and the third complex 78 and is set at a period of time from 10:00 am to 7:00 pm (at business hours of facilities).

The first traveling route 82 is a route for moving around the square 80 in front of a station, the second traveling route 88 is a route for linearly reciprocating between the stations, and the third traveling route 86 is a route for moving around the complexes. In this manner, the traveling route of the moving object 10 is set based on time-of-day information. Accordingly, the traveling route of the moving object 10 can be set in accordance with what is in demand at commute hours or the business hours of facilities. Note that, the number of kinds of traveling routes is not limited to three and there may be a larger number of kinds of traveling routes.

In addition, the traveling speed of the moving object 10 traveling along the second traveling route 88 and the traveling speed of the moving object 10 traveling along the third traveling route 86 may be different from each other. For example, the moving object 10 traveling along the second traveling route 88 travels at a speed of 5 km per hour and the moving object 10 traveling along the third traveling route 86 travels at a speed of 3 km per hour. That is, the traveling speed of the moving object 10 is set depending on the traveling route. Accordingly, it is possible to move a user moving between the stations during commute hours at a high speed and move a user going to a complex at a low speed.

The traveling speed of the moving object 10 may be set depending on the time of day. For example, the traveling speed may be set to a high speed at commute hours and may be set to a lower speed than commute hours at the business hours of the facilities. Accordingly, it is possible to increase the traveling speed of the moving object 10 in a situation where a pedestrian is in a hurry like commute hours.

In addition, the traveling speed of the moving object 10 may be set to a high speed of 5 km per hour in a case where the moving object 10 moves to a destination after destination information is received from an occupant. That is, the traveling speed is set depending on whether or not a destination has been set. Accordingly, the moving object 10 can wander around the square 80 in front of a station at a low speed to gather occupants and can move to a destination at a high speed when the destination is set by an occupant.

The traveling speed of the moving object 10 may be set based on both or one of the traveling position and the traveling direction. The third traveling route 86 shown in FIG. 11 includes a first section 90 where the moving object 10 travels in a direction away from the first station 70 and a second section 92 where the moving object 10 travels in a direction toward the second station 72. In the first section 90, the moving object 10 travels toward the second complex 76 and the third complex 78 from the first station 70 and travels at a low speed of 3 km per hour. In addition, in the second section 92, the moving object 10 travels from the second complex 76 and the third complex 78 at a high speed of 5 km per hour. In other words, the traveling controller 32 makes the speed of travel from the station to the complexes relatively low and makes the speed of travel from the complexes to the station relatively high. Accordingly, the occupant can visit other facilities with time to spare when going to the complexes and return to the station quickly. In this manner, even for the same time of day and the same traveling route, traveling information in which the traveling speed is set to be different depending on both or one of the traveling position and the traveling direction is derived.

The deriving unit 60 of the server apparatus 12 derives traveling information in which the traveling speed and the traveling route of the moving object 10 are defined. The deriving unit 60 distributes the moving objects 10 to the first traveling route 82 and the second traveling route 88 at commute hours and distributes the moving objects 10 to the first traveling route 82 and the third traveling route 86 at the business hours of the facilities. For example, at commute hours, 80% of the moving objects 10 are set to the second traveling route 88 and 20% of the moving objects 10 are set to the first traveling route 82. The management unit 62 decides traveling information for the moving objects 10 in accordance with derived distribution and transmits the determined traveling information to each of the moving objects 10. The traveling controller 32 of the moving object 10 controls traveling of the moving object 10 in accordance with the traveling information derived by the deriving unit 60.

Note that, the embodiments are merely examples and it is understood by those skilled in the art that various modifications can be made for the combination of the constituent elements and such modifications are also encompassed in the scope of the disclosure.

In the embodiments, the moving object 10 autonomously travels based on position information by using the GPS. However, the disclosure is not limited thereto. For example, a belt may be put on a road surface along a traveling lane set in advance such that the moving object 10 travels along the belt. The moving object 10 may travel along the belt based on a magnetic wave output from the belt and may travel along the belt detected through image analysis.

What is claimed is:

1. A movement control system comprising:
a traveling controller configured to control, based on traveling route information, traveling of a moving object which a person is able to get on and off while the moving object is traveling;
an output unit configured to output, to an occupant, information about a facility in a traveling area of the moving object; and
a receiver configured to receive an inputting operation performed by the occupant for use or purchase of a service or a product provided in the facility.

2. The movement control system according to claim 1, further comprising:
an acquisition unit configured to acquire destination information of the occupant getting on the moving object; and
a deriving unit configured to derive traveling route information based on the acquired destination information.

3. The movement control system according to claim 1, further comprising a settlement unit configured to perform settlement for a service or a product received.

4. The movement control system according to claim 2, wherein the traveling controller causes the moving object to travel along a traveling route set in advance until the destination information of the occupant is acquired.

5. A movement control method comprising:
a step of controlling, based on traveling route information, traveling of a moving object which a person is able to get on and off while the moving object is traveling;
a step of outputting, to an occupant, information about a facility in a traveling area of the moving object; and
a step of receiving an inputting operation performed by the occupant for use or purchase of a service or a product provided in the facility.
